(19) United States
(12) Patent Application Publication
(10) Pub. No.: US 2011/0255761 A1
(43) Pub. Date: Oct. 20, 2011

(54) METHOD AND SYSTEM FOR DETECTING LUNG TUMORS AND NODULES

(75) Inventors: Walter O'Dell, Ontario, NY (US); Robert Ambrosini, Rochester, NY (US); Peng Wang, Rochester, NY (US)

(73) Assignee: University of Rochester, Rochester, NY (US)

(21) Appl. No.: 12/666,725

(22) PCT Filed: Jun. 26, 2008
(86) PCT No.: PCT/US08/68407

§ 371 Date: Nov. 15, 2010

Related U.S. Application Data
(60) Provisional application No. 60/929,421, filed on Jun. 26, 2007.

(51) Int. Cl. G06K 9/00

(52) U.S. Cl. 382/131; 382/128

(57) ABSTRACT

A method and system for detecting tumors and nodules in a lung tissue are provided. The method includes the steps of (a) providing a plurality of asymmetric templates of at least one 3D appearance model of a nodule; (b) providing a 3D imaging data set of the entire area of a tissue; (c) matching the 3D imaging data set of the entire area of the tissue with each of the plurality of asymmetric templates to search for 3D objects in the tissue that match the at least one 3D appearance model; (d) determining the volume of the 3D objects found in the tissue; and (e) providing an output representing 3D objects that match the 3D appearance model.

### CROSS-REFERENCE TO RELATED APPLICATIONS

This application is the U.S. national phase of PCT International Patent Application No. PCT/US2008/068407, filed Jun. 26, 2008, published on Dec. 31, 2008, as WO 2009/003128 A2, which claims the benefit of U.S. Provisional Patent Application No. 60/929,421, filed Jun. 26, 2007 in the U.S. Patent and Trademark Office, titled “IMAGE PROCESSING METHOD FOR COMPUTING VOLUME OF TUMORS AND NODULES FROM ED MEDICAL IMAGES”, the entire disclosure of which is incorporated herein by reference.

This application is also related to the subject matter disclosed in U.S. Provisional Patent Application No. 60/598,844, filed Aug. 5, 2004 in the U.S. Patent and Trademark Office, titled “AUTOMATIC COMPUTER AIDED DETECTION OF TUMOR USING 3D TEMPLATE MATCH,” the entire disclosure of which is incorporated herein by reference.

### FIELD OF THE INVENTION

The present invention relates to a method and device for detecting tumors in a lung tissue, and more particularly, to an automatic computer detection method for detecting tumors or metastatic nodules in the lung of a patient at an early stage, using computed tomography (CT) scans of the chest and three-dimensional (3D) spherical models simulating tumors.

### BACKGROUND OF THE INVENTION

The lung is the most frequent site of primary cancer and lung cancer is the leading cause majority of cancer patients today die of metastatic disease rather than the uncontrolled growth of the primary cancer. For example, among women who die of breast cancer, 57-77% have metastases to the lung, and the lungs are exceeded only by bone as the most common sites of metastases. Among those patients who die of colorectal cancers, almost half have lung metastases, and among those succumbing of sarcoma or of head and neck cancer, almost all have lung metastases.

In the early stage of lung metastases, the number and locations of metastatic tumors are usually limited, a concept termed oligometastases. It is also hypothesized that late-onset metastatic tumors may be derived from the early-onset lesions, and therefore eliminating the first stage of metastatic disease could greatly ameliorate the development of secondary metastatic tumors. Unfortunately, traditionally the utility of radiation to control lung disease has been limited by the lungs' poor radio-tolerance. Recent advances in hypofractionated, conformal, high-dose stereotactic radiosurgery/radiation therapy have made it possible to deliver lethal radiation doses to surgically precise locations thereby expanding the size of lesions that are treatable and the scope of patients who can be considered as candidates for curative treatment of their cancer. This technique has been applied using, for example, a Novalis Shaped Beam Surgery System, made by BrainLAB AG, Heimstetten, Germany, to treat extra-cranial metastatic tumors. The result of this technique achieved local control rates of 88% for metastases to the liver and 94% for metastases to the lung.

The application of stereotactic radiosurgery to pulmonary targets (PSRT) opens the door for curative treatment of lung cancer and for improving the survival of patients with metastases, but only if the tumors can be detected at a stage where they are small enough to enable the use of lethal radiation dose levels. At small sizes, however, the presence of metastatic tumors is not discerned by the patient and not detectable using clinical pulmonary function tests, hence the need for lung tumor screening via medical imaging. Three-dimensional (3D) medical imaging modalities, specifically serial section X-ray CT and magnetic resonance imaging (MRI), have become increasingly popular for screening of pulmonary cancer.

Serial section CT has been shown to drastically increase lung tumor detection rates, compared with radiologists' results using only projection chest X-rays, and the average size of tumors detected has been reduced from 30 mm to 12 mm. Whereas a thoracic CT scan using a single detector scanner typically generates 40 to 100 axial image slices, the newer, multi-detector scanners typically generate 300 to 600 image slices. To read and interpret these massive amounts of image data requires substantial amount of radiologist effort and predisposes the screening process to human error and missed detection of cancerous lesions.

In “Screening for lung cancer with low-dose spiral computed tomography,” American Journal of Respiratory & Critical Care Medicine 165, 508-513 (2002), Swensen et al. found that when retrospective interpretation of baseline lung images is performed, nodules are found to have been initially missed in 26% of subjects. A chief concern is the nodules of small size, low contrast, or those located near vessel structures, since these nodules are often missed by the unaided radiologist. Thus, computer-aided diagnostic (CAD) approaches are becoming increasingly necessary for both reducing radiologists' effort and improving detection sensitivity.

Various CAD methods have been proposed to detect lung nodules from serial section image sets. Most methods consist of three steps: 1) pre-processing: segmentation of lung field, filtering of data, etc.; 2) selection of initial nodule candidates; and 3) post-processing: analyzing features of initial nodule candidates and eliminating false positives. The existing CAD methods can be divided into two major groups based on the different strategies used in nodule selection and analysis: intensity-based and feature-based (model-based). The intensity-based methods distinguish initial lung nodule candidates from lung parenchyma by their relative high intensity in CT images. This step can be done in 2D (slice-by-slice processing) or in 3D (3D segmentation). Then additional features of each initial candidate are extracted, including 2D features such as area, eccentricity, circularity, irregularity, compactness; and 3D features such as volume, sphericity, 3D compactness, and mean intensity value. Classifiers are then applied on those features to exclude false positives. Examples of intensity-based methods are region-growing, combination of attenuation thresholding and region growing, fuzzy clustering, K-mean clustering, and gray-scale thresholding. Feature-based methods take into consideration the nodules' compact spherical shape, together with other information such as overall size, density, texture, etc., to establish models of lung nodules. Examples are model-based similarity measures, pattern classification, template matching using a genetic algorithm, “N-Quoit” spatial filtering, object-based deformation, morphological analysis, multistage anatomic model, and patient-specific models. Results from these and related CAD algorithms are encouraging in general; however, most current CAD schemas suffer from a miss-rate of 10-30% (low sensitivity) and, at the same time, generate a large number of false-positives (low specificity). A high false positive rate is undesirable because it defeats the objective of reducing the effort required of the attending radiologist. Moreover, it is quite unfavorable for a CAD method to miss detecting a tumor that is present in a patient.

The primary challenge for radiologists and CAD systems alike for lung tumor detection is that in cross sectional images there are many objects that have the same appearance and voxel intensity as tumor nodules. Most of these objects are blood vessels coursing obliquely through the image plane. In a cross-sectional slice, a cylindrical vessel can appear circular, and many vessels in the lung have a similar diameter to the tumors of interest. A primary failing point of most CAD systems referenced above is that they depend upon a first-pass detection of candidates based on 2D image features, producing hundreds of first-pass candidates. The CAD systems then employ various schemes to tackle the enormous task of removing likely false positives from the vast candidate pool, with varying degrees of success. A common problem is that in filtering out the large volume of false positives, true positives are also omitted; creating a system that is prone to missing true tumors yet maintains a relatively high false positive count.

### SUMMARY OF THE INVENTION

The present invention is motivated by the observation that experienced radiologists screen for lung tumors not by considering individual image slices independently, but by paging through the image stack looking for 3D appearance characteristics that distinguish tumors from vessels. On consecutive images, vessels maintain a similar cross-sectional size and their in-plane circular appearance appears to drift across the viewing screen from one slice to the next, following the tortuous anatomy of the vessel. True lung tumors, in contrast, appear as circular objects that remain at approximately the same on-screen location from slice to slice. Their size quickly increases and then just as rapidly decreases and the tumor disappears after a few slices. In essence the radiologist is constructing in his or her mind a 3D model of the tumor anatomy and the interaction of that 3D object with the serial image slices. The approach of the present invention is to construct a 3D model of the imaging features of a spherical tumor and then to perform a search through the 3D imaging volume for objects that are similar to the 3D tumor appearance model. One advantage of the present invention is to provide an automatic detection of tumors between 4 and 20 mm in diameter in the lungs of patients at high-risk for developing metastatic disease. The purpose is to determine the optimal parameters for tumor appearance models and the detection capture range in regards to tumor size, tumor eccentricity, and image quality using simulated image datasets, and to establish the sensitivity and specificity of our algorithm in human lung datasets.

The aim of the present invention is to demonstrate a novel, fully automatic computer detection method applicable to metastatic tumors to the lung with a diameter of 4-20 mm in high-risk patients using typical computed tomography (CT) scans of the chest. In the present invention, three-dimensional (3D) spherical tumor appearance models (templates) of various sizes were created to match representative CT imaging parameters and to incorporate partial volume effects. Taking into account the variability in the location of CT sampling planes cut through the spherical models, three offsetting template models were created for each appearance model size. Lung volumes were automatically extracted from computed tomography images and the correlation coefficients between the sub-regions around each voxel in the lung volume and the set of appearance models were calculated using a fast frequency domain algorithm. To determine optimal parameters for the templates, simulated tumors of varying sizes and eccentricities were generated and superposed onto a representative human chest image dataset. The method was applied to real image sets from twelve patients with known metastatic disease to the lung. A total of 752 slices and 47 identifiable tumors were studied.

Spherical templates of three sizes (6, 8, and 10 mm in diameter) were used on the patient image sets, all 47 true tumors were detected with the inclusion of only 21 false positives. The present invention demonstrates that an automatic and straightforward 3D template-matching method, without any complex training or post-processing, can be used to detect small lung metastases quickly and reliably in the clinical setting.

One aspect of the present invention is a method and system for detecting tumors and nodules in a lung tissue, by (a) providing a plurality of asymmetric templates of at least one 3D appearance model of a nodule; (b) providing a 3D imaging data set of the entire area of a tissue; (c) matching the 3D imaging data set of the entire area of the tissue with each of the plurality of asymmetric templates to search for 3D objects in the tissue that match the at least one 3D appearance model; (d) determining the volume of the 3D objects found in the tissue; and (e) providing an output representing 3D objects that match the 3D appearance model.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a flowchart of a process of a system for detecting lung tumors or nodules according to an exemplary embodiment of the present invention.

FIG. 2 illustrates models simulating a tumor or nodule having three consecutive image slices according to an exemplary embodiment of the present invention.

FIG. 3(a) shows one slice through the simulated tumor image stack according to an exemplary embodiment of the present invention.

FIG. 3(b) shows the corresponding correlation map computed using a template at the location of the image slice of FIG. 3(a).

FIG. 3(c) shows a correlation map at a image slice adjacent to the slice shown in FIG. 3(a).

FIG. 4 is a graph of a tumor size capture range for various-sized appearance models according to an exemplary embodiment of the present invention.

FIG. 5(a) is one slice from a patient scan showing 2 lung tumors identified by a radiologist.

FIG. 5(b) is the corresponding correlation map computed using a 6 mm template at the location of the image slice of FIG. 5(a).

FIGS. 6(a)-(f) show examples of false positive findings.

FIG. 7 shows a system for detecting tumors and nodules in the lung tissue according to an exemplary embodiment of the present invention.

### DETAILED DESCRIPTION OF THE PREFERRED EMBODIMENTS

Hereinafter, exemplary embodiments of the present invention will be described in detail. However, the present invention is not limited to the embodiments disclosed below, but can be implemented in various forms. The following embodiments are described in order for this disclosure to be complete and enabling of practice of the invention by those of ordinary skill in the art.

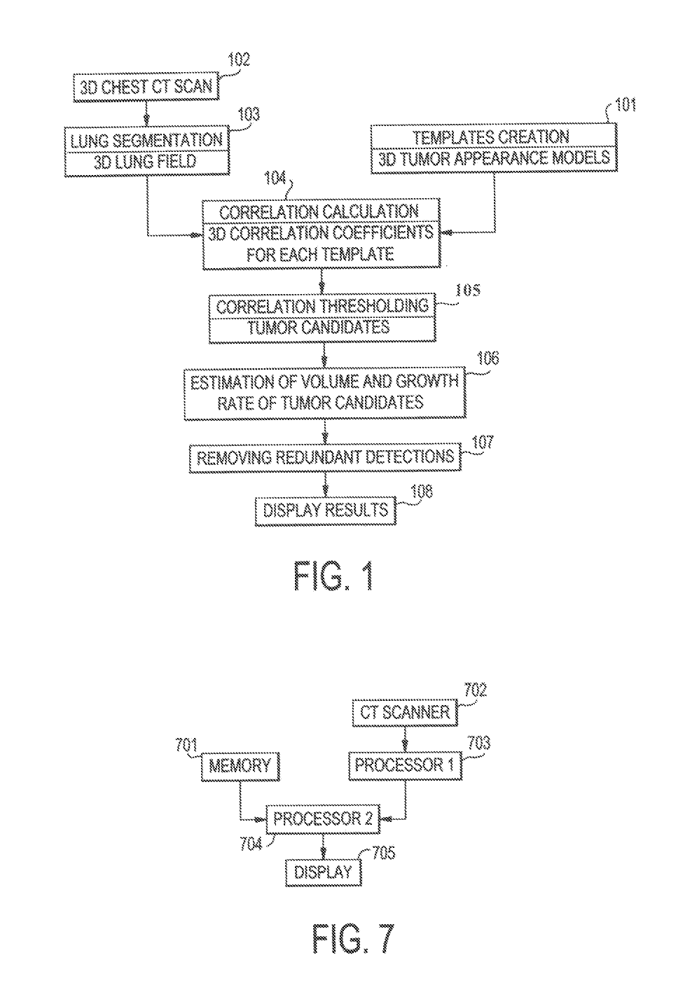

FIG. 1 shows a flowchart of a process of a system for detecting lung tumors or nodules according to one exemplary embodiment of the present invention. In step 101, templates of 3D appearance models of tumors are created. In step 102, 3D CT scans of the chest of a patient are obtained. The scans show images of slices of the chest. In step 103, lung segmentation is processed. As described in detail below, this process produces 3D imaging data of the lung parenchyma without the surrounding soft tissue or bones and without the blood vessels, lesions, or the like inside the lung region. The 3D imaging data of the lung parenchyma remains. In step 104, the system calculates the 3D correlation coefficient between the 3D imaging data of the lung parenchyma and each template of the tumor-appearance models. In step 105, when the correlation coefficient calculation generates matching data between the 3D imaging data of the lung and the templates, the system determines whether the correlation surpasses a threshold which signifies that the detected nodules are tumor candidates. In step 106, after obtaining the tumor candidates, the system estimates or determines the volume of the tumor candidates. The volume estimation method is performed at various time points, and the growth rate may be then determined and monitored as the estimated volume of the tumors changes over time. In step 107, when an individual tumor matches multiple tumor-appearance models, the redundant counts are eliminated. In step 108, the results of tumor candidates are outputted.

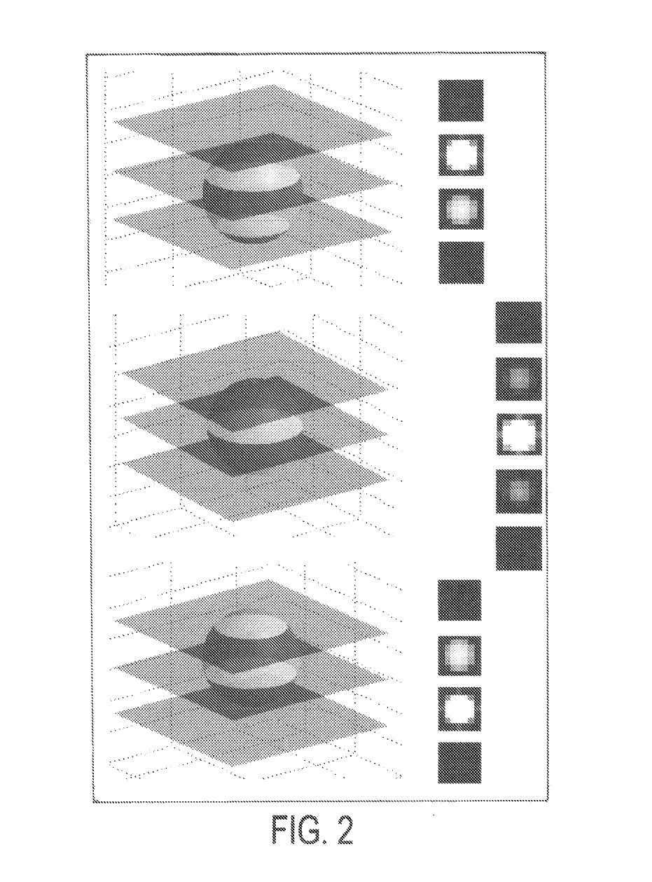

With respect to the templates creation step 101, FIG. 2 shows a plurality of asymmetric templates of 3D appearance models of tumors. In FIG. 2, the 3D appearance model sphere is a tumor 6 mm in diameter of uniform density, constructed on a dark background. The imaging parameters are chosen based on a representative patient image data set: in-plane pixel size of 1×1 mm and slice thickness and slice separation of 3 mm. FIG. 2 also shows the results for the instance when a CT image slice intersects the exact center of the sphere (middle of figure) and with the image slices offset by plus (top of figure) and minus (bottom of figure) ⅓ of the slice thickness. The partial volume of the sphere in each voxel is taken into consideration for each slice that is intersected by the sphere to give variable gray-scale voxel intensities both in-plane and through the slice thickness. An optimal in-plane padding (determined in simulation) is added to each tumor appearance model. An out-of-plane padding slice is added whenever an end slice average intensity value is more than a maximum threshold of 20%. Thus the centrally located tumor model is given an out-of-plane padding slice at both ends, while the two offset models typically include a padding slice at one end as shown in FIG. 2.

Regarding the lung segmentation process 103, to speed up the computation, an automatic lung segmentation procedure is performed to remove from consideration objects outside the lung region. An initial histogram-based thresholding step isolated the lung parenchyma from the surrounding soft tissue and bones. This is followed by a series of morphological operations that remove from within the lung space the vessels, lesions, and other relatively small objects. The resulting modified binary image is then used as a mask to extract out only the lung tissue, over which the search for tumor candidates is then performed. In order to include into the analysis tumors attached to pleura, 3D morphological operations are applied on the initial lung mask.

With respect to step 104, the next task is to search the serial lung image stack for 3D objects that match the 3D appearance model. This is essentially a 3D template-matching scheme to evaluate the similarity between sub-regions around each voxel in the image stack and the templates. A search over the entire lung volume is performed computationally using the 3D normalized cross correlation coefficient (NCCC) given in Equation 1. First, the covariance Cov_{xy} is computed by calculating the average and variance for each of two sampled datasets, X & Y. Then the covariance is normalized by dividing by a term involving the individual variances Sₓₓ² and S_{yy}², giving the 3D NCCC.

$$\overline{x} = \frac{1}{n} \sum {x}_{i} , \overline{y} = \frac{1}{n} \sum {y}_{i} \\ {S}_{xx}^{2} = \frac{1}{n - 1} \sum {( {x}_{i} - \overline{x} )}^{2} , {S}_{yy}^{2} = \frac{1}{n - 1} \sum {( {y}_{i} - \overline{y} )}^{2} \\ {Cov}_{xy} = \frac{1}{n - 1} \sum ( {x}_{i} - \overline{x} ) ( {y}_{i} - \overline{y} ) \\ NCCC = \frac{{Cov}_{xy}}{\sqrt{{S}_{xx}^{2} \cdot {S}_{yy}^{2}}} \qquad ( 1 )$$

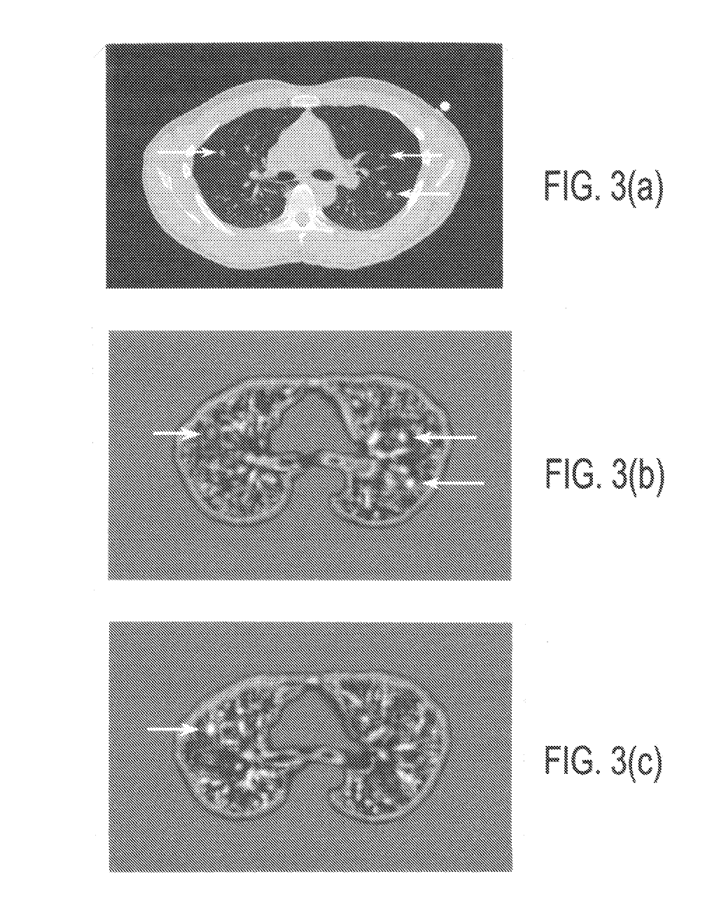

Here, dataset ‘X’ is the serial slice voxels in the appearance model, and the dataset ‘Y’ is the correspondent sub-region voxels in the patient medical image slices. An NCCC value is computed at each lung voxel, as shown in FIGS. 3(b)-(c). A perfect match is represented by a 1.0 normalized correlation value; a random sampling would give a 0.0 correlation value. Thus local maxima in the correlation results correspond to tumor candidates. To speed up the computation, the calculation of NCCC may be accomplished in the Fourier domain of the image and of the template.

FIG. 3(a) shows one slice through the simulated tumor image stack. The 3 arrows point to simulated tumors. FIG. 3(b) shows the corresponding correlation map computed using a 6 mm template, at the image slice location in (a). FIG. 3(c) shows the correlation map at an adjacent slice. The gray-level values at each voxel in the correlation map represent the normalized 3D cross-correlation coefficient between the 3D tumor model of interest and the 3D patient image dataset. The simulated tumor in the upper left of the image (a) is not centered on the current image slice, thus even though the tumor is apparent in the CT image, its correlation match is more apparent on the adjacent slice (c).

Referring to step 107 of FIG. 1, one approach according to an exemplary embodiment of the present invention is to utilize multiple tumor appearance models to capture tumors over a range of sizes. In this approach, it is possible for individual tumors to become matched to multiple tumor appearance models. To eliminate redundant counts we recorded the central location of each tumor, as determined from the local maximum correlation value at each site satisfying the threshold criterion. Two or more detections are considered to come from the same tumor if the central locations are within the radius of the model.

Regarding simulated tests, for the initial testing phase, realistic human lung image datasets with simulated tumors are generated. To achieve realistic tumor images, simulated spherical tumors with non-integer sizes and ellipsoidal tumors with different eccentricity, orientations, and sub-slice thickness locations are created. Spherical test tumors are created with diameters in the range 4.1 to 12.5 mm. Ellipsoids (prolate spheroids) are generated with axis ratio ranging from 1.25 to 2.0, and minor axis diameters ranging from 4.5 to 10.5 mm. The resulting computer-generated test tumors are then blurred with a Gaussian filter to mimic the point spread function of the typical clinical imaging scanner. These simulated tumors are then superposed onto the 3D medical image sets of a representative patient and centered at sub-voxel positions determined by a random number generator. Finally, the voxel intensity values across the entire image set are given a Gaussian perturbation of varying standard deviation up to twice the intrinsic noise of a typical scan. In this manner datasets are generated with multiple simulated tumor to determine optimal parameters of templates (size, padding and threshold) to study the effects of tumor size and image noise on detection performance.

Regarding human datasets, a small-scale study is performed using image data acquired on patients with lung metastases treated using PSRT at the Department of Radiation Oncology of University of Rochester in Rochester, N.Y. The images are acquired using a standard GE Genesis Lightspeed CT clinical scanner (GE medical system, Milwaukee, Wis.) with slice thickness: 3 mm; slice separation: 3 mm; in-plane resolution: 0.9375 mm; tube voltage 120 kV and tube current 70-120 mA. All images are acquired during a 20-30 second end-expiration breath-hold, and with no injected contrast. This imaging protocol is typical of routine follow-up and screening of high-risk patients. The presence and location of 47 tumors of diameter approximately 4-20 mm across 12 datasets are determined by a radiologist and confirmed by an experienced radiation oncologist. The optimal template parameters determined from the analysis of the simulated tumor datasets are applied on the in-house human datasets.

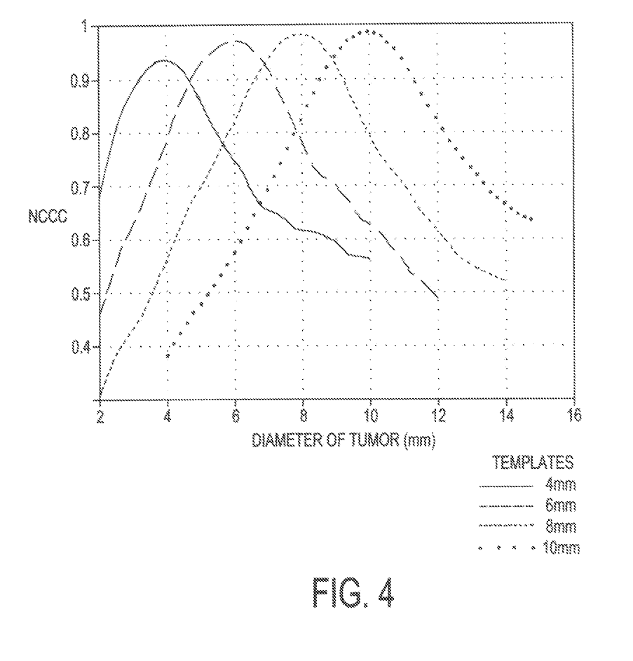

Regarding the results of the tests, in order to choose the adequate template sizes for the desired tumor detection range, tumor capture range is evaluated using the simulated tumor image sets, as shown in FIG. 4.

FIG. 4 shows a tumor size capture range for various-sized appearance models, based on simulated tumor datasets. The horizontal axis is the diameter of the simulated spherical tumor. Plotted on the vertical axis is the lowest individual NCCC for any tumor at each diameter. For a given simulated tumor the individual NCCC value is determined by computing the maximum NCCC among the three template varieties. The individual NCCC value varies among the multiple tumors at any given tumor diameter depending on several factors, including the tumor position offset. The highest individual NCCC is found for tumors offset exactly by 0 and ±⅓ slice spacing (identically matching the appearance models, FIG. 2). The lowest individual NCCC occurs for those tumors with the greatest misalignment (offset by ±½ slice spacing). The left-most curve represents the lowest individual NCCC for a 4 mm diameter tumor appearance model against simulated tumors of size 2 to 10 mm in diameter. The remaining curves, going from left to right, are the plots for tumor appearance models of 6, 8, and 10 mm diameter, respectively. For example, using a correlation threshold of 0.7 would enable the 6 mm model to detect tumors of size range 3.5 to 9.0 mm diameter, but miss other-sized tumors.

At a typical NCCC cut-off of 0.70, the capture curves for the three templates with diameters 6, 8 and 10 mm overlap with each other to form a continuous spectra covering tumor diameter of 4-13 mm. Using these three sizes, the optimal padding and correlation coefficient thresholds for each size are determined by reducing the number of false positive findings in the simulation image sets while retaining all the simulated tumors. The resultant optimal in-plane paddings are 1, 2 and 2 pixels and correlation thresholds values are 0.75, 0.68, and 0.68 for the 6, 8, and 10 mm models, respectively.

Regarding the tumor detection versus image noise on the simulated datasets, the addition of Gaussian noise with standard deviation 0, 10, 26, and 52 Hounsfield Units (up to twice that of intrinsic noise) did not alter the detection rate of simulated tumors. Using the optimal paddings and thresholds, the number of false positives (1-2 per case) did not change with the increased noise level.

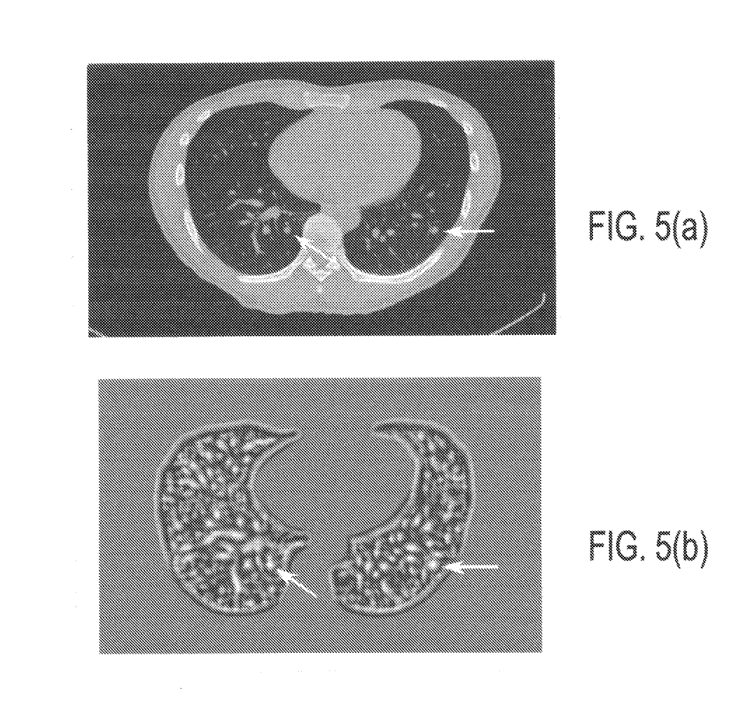

Regarding tumor detection results on in-house human datasets, the optimal tumor model parameters determined from the simulated tumor datasets are applied to the analysis of human serial CT datasets acquired on patient subjects treated for lung metastases. Twelve patient datasets with 752 image slices and a total of 47 lung tumors ranging from approximately 4 to 20 mm in diameter are processed. Several juxta-pleural nodules are present in these datasets and all are correctly excluded from the chest wall during the lung segmentation step. Three templates sizes are used: 6, 8, and 10 mm. For each size, three appearance models are created: one with the tumor model situated exactly in the center of an image plane, one with the model shifted 1 mm above the central cut-plane, and one with the model shifted down 1 mm, as depicted in FIG. 2. Thus, nine appearance models are used to scan the CT image datasets for tumor candidates. The computation of the 3D NCCC for all nine appearance models, each with an approximately 70-slice lung image set, took approximately 5 minutes on a 1.8 GHz PC running MATLAB version 6.5 with the fast NCCC algorithm. Using the optimal paddings and correlation threshold values determined in the simulation, the algorithm detected all 47 tumors together with the citing of 21 false positives. The false positive rate expressed as the ratio of false positives to true positives is 0.45. The average false positive per patient scan is only 1.8 per case; while the number per image slice, a more common index seen in the literature, is 0.028. FIG. 5 shows an example of a patient slice with 2 real tumors and the corresponding correlation map computed using a 6 mm template.

Referring to FIGS. 5(a) and (b), FIG. 5(a) shows one slice from a patient scan showing 2 lung tumors identified by a radiologist, indicated by the white arrows. FIG. 5(b) shows the corresponding correlation map computed using a 6 mm template, at the image slice location. Though not readily appreciated in this rendering, the centers of the 2 tumors are the brightest objects in the correlation map.

An FROC analysis is performed producing a curve with a sharp upward slope that achieved a sensitivity of 1.0 (100%) at a false positive rate of 1.8 false positives per CT scan and achieved zero false positives at a sensitivity of 0.26. The low number of false positives resulted in a curve that is not smoothly varying but is inflected where the rate at which false positives are excluded is not less than the rate at which the true nodules are omitted. This shape and the rapid achievement of 100% sensitivity make FROC analysis a less useful tool for evaluating this approach.

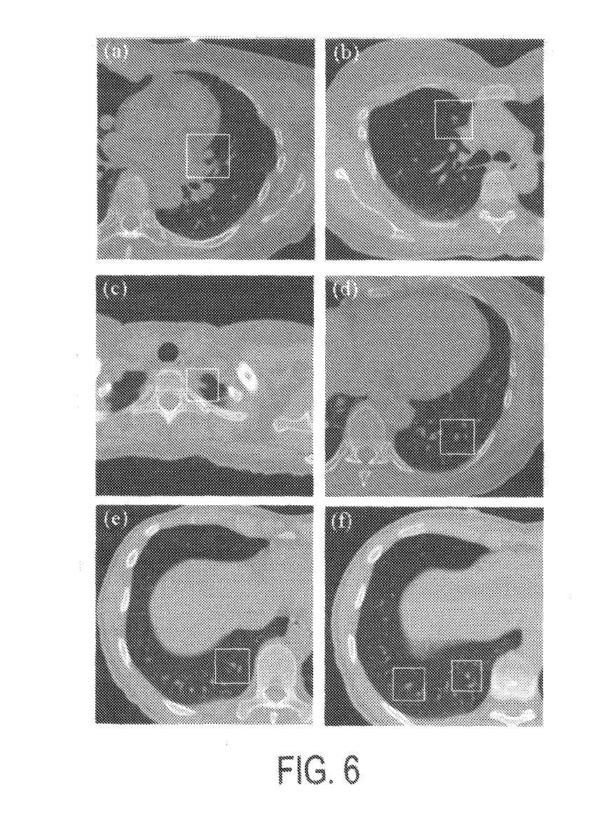

Regarding the false positive findings, the major sources of false positive findings include: structures that are attached to the heart or chest wall; branching/joint regions of thick blood vessels; and blood vessels disrupted by motion artifacts. FIG. 6 demonstrates some typical false positives.

Referring to FIG. 6, FIG. 6 shows examples of false positive findings. The size of each example is 200×200 pixels (187.5×187.5 mm). Shown in the center of each white box is the false positive object. In FIGS. 5(a)-(c), false positives occurred at anatomic structures adjacent to pleura and/or cardiac surfaces; in FIG. 5(d), the false positive was a branching region of a blood vessel; and in FIGS. 5(e)-(f), false positives occurred in proximity to the diaphragm where respiratory motion artifacts can disrupt the appearance of blood vessels.

In summary, a novel 3D template-matching algorithm has been introduced for the automatic detection of small lung tumors from serial CT image slices. The method is based on the construction of 3D models of the appearance of small metastatic tumors in volumetric medical imaging datasets and this method is applicable to standard CT imaging protocols without the need for injected contrast. On patient CT images with tumors ranging from 4 to 20 mm in diameter, the method achieved a 100% detection rate with 1.8 false positives per case. The process of the system in the present invention is also shown robust to simulated image noise and is insensitive to variations in the target contrast. Since the normalized cross correlation coefficient relies on the relative intensity contrast between the tumor and the background tissue, rather than on the physical properties of any individual imaging modality, the detection method can be used with other volumetric imaging modalities such as MRI and 3D ultrasound. It can also be adapted to detect tumors with compact geometry at other anatomic sites, such as the brain. The essence of the present invention is that small metastatic tumors take on an approximately spherical shape, and this is found to be true much of the time. However, the detection method is found also to be perceptive to highly eccentric simulated tumors and to true tumors that do not appear spherical in shape and that are far larger (up to 20 mm) than the largest appearance model (10 mm). In contrast to previous automatic tumor detection methods, the present invention method does not require an elaborate set of classifiers or lengthy training/learning, or complex image pre-processing. This is primarily because the present invention works intrinsically in three dimensions to select the 3D tumors from 3D image datasets, obviating the collection of numerous first-pass false positives.

The stated aim of the present invention is to optimize model parameters for the detection of nodules 4-13 mm in diameter. A concern of the template matching approach is that to capture tumors of greater size, a large number of additional templates would be needed, increasing the computational demand. However, as mentioned above, the selected tumor appearance models are able to pick up much larger tumors, with diameters up to 20 mm. In addition, with the increase of tumor size the effect of partial volume is diminished, eliminating the need for the ±⅓ slice offset template varieties. Also, since there are very few normal structures in the lung at larger sizes, the NCCC threshold can be loared without the risk of increasing the number of false positives. Additional simulations are performed and showed that a central 14 mm diameter template is able to capture simulated tumors up to 34 mm in diameter without accruing any additional false positives, using a threshold of 0.52.

In comparison to previously published CAD methods, the method presented herein is the only one to employ a fully 3D approach, except for Lee et al. in “Automated detection of pulmonary nodules in helical CT images based on an improved template-matching technique,” IEEE Transactions on Medical Imaging 20, 595-604 (2001). The present invention is the first to utilize a frequency-domain based 3D normalized cross correlation coefficient computation and the first to employ image partial volume effects in 3D which assist in making template matching efficient and sensitive to even very small nodules imaged with conventional pixel sizes. The present invention is also the first to use 3D morphological operations for lung segmentation. Whereas other methods often perform a sequential series of computations including median filtering and selection for nodule candidate size, shape, contrast and 3D connectivity, the 3D template matching approach incorporates all these processes into the calculation of a single parameter—the normalized cross-correlation coefficient. This obviates the need to perform an often complex search over a multidimensional parameter space for a global optimum. It is noted that the current realization of this algorithm running in MATLAB 6.5 on a 1.8 GHz Windows NT machine could be further optimized for computational speed using appropriate hardware and software modifications thereby reducing considerably the 5-minute per patient processing time. However, in its current state the method appears to take approximately the same or less computation time as previously published methods, at least for those methods for which computational estimates are given.

The advantages of the present invention, in comparison to Lee et al.'s approach, are that it uses asymmetric templates to address the non-isotropic resolution in CT scans; uses padding and variant overall template sizes to reduce the influence of background; assumes a more tumor-like uniform spherical profile model instead of a standard Gaussian profile; and searches the entire lung field using a fast Fourier domain algorithm rather than sparse sampling using a Genetic Algorithm. These differences eliminated the need for an extra computational step to reduce the number of false positives.

A larger-scale analysis of the present invention is conducted using the Early Lung Cancer Action Project (ELCAP) lung image database, consisting of 50 sets of serial low-dose CT image datasets from lung patients. The major challenges of ELCAP data include: lower signal-to-noise ratio (SNR) due to low exposure dose—moderate to severe streak artifacts; larger amount of data—an average of 255 slices per subject; and smaller nodules to detect—most are less than 7 mm in diameter and some are as small as 3 mm.

An active area of research is to quantify nodule volume and growth in order to differentiate active tumors from benign nodules. The ELCAP study found that 233 (23%) of the 1000 initial subjects presented with 1-6 pulmonary nodules on their first screening. Follow-up screenings on these 233 subjects determined that only 7 (3%) of these subjects had lung cancer. It is estimated that nodules that do not grow measurably in volume in a 6-month time-frame carry a malignancy risk of less than 10%. FIG. 4 demonstrates the influence of appearance model size on the correlation coefficient for each of a range of tumor sizes. These curves show that an optimal correlation value is obtained when the size of the appearance model matches the size of the given tumor. This observation suggests that accurate tumor size estimates may be obtained by adjusting the computer-generated appearance model size to obtain a maximal correlation value to a given tumor, having identified each tumor's location in a previous step.

FIG. 7 shows a system 700 for detecting tumors and nodules in the lung tissue according to an exemplary embodiment of the present invention. In FIG. 7, a memory 701 creates and stores asymmetric templates of 3D appearance models of tumors and metastatic nodules. A 3D CT scanner 702 may be used to provide the scans of the chest area. A first processor 703 receives the 3D imaging scans of the chest area to extract 3D imaging data set of the entire area of the lung tissue. The first processor 703 removes data information of areas surrounding the lung tissue and eliminates data related to blood vessels, lesions and the like inside the lung area. Subsequently, the second processor 704 searches the entire lung tissue for 3D objects that match the 3D appearance models in the templates by calculating the 3D normalized cross-correlation coefficients according to aforementioned Equation (1). When a plurality of appearance models are used, the second processor 704 also removes any redundant counts when an individual tumor matches multiple tumor appearance models. In addition, the second processor 704 determines the volume of the tumors that match the appearance models. The tumor volume is estimated or determined by finding, among the plurality of templates of various sizes, the template that has the best correlation fit. For the instance when two templates of different sizes are both found to match to approximately the same high correlation value, a new set of asymmetric templates is created of an intermediate size between the two initial templates. The correlation values for these new templates is computed and compared to the initial two templates.

If the there is a new maximum correlation values among the new template, then the new template and the initial template with the highest correlation value are treated as the two initial templates and the process repeated. This process is repeated iteratively until a new template size is found that maximizes the correlation value to within a prescribed small error. The volume estimation method described above is performed at various time points, and the growth rate of the tumors may be then determined and monitored as the estimated volume changes over time. In FIG. 7, the results from the second processor 704 are displayed in the display 705.

While the invention has been shown and described with reference to certain exemplary embodiments thereof, it will be understood by those skilled in the art that various changes in form and details may be made therein without departing from the spirit and scope of the invention. For instance, although the present invention utilizes 3D image data, it is not limited to any specific imaging modality. The method, thus, is equally applicable to MRI, 3D ultrasound, cone-beam CT, 3D optical tomography, etc. The present invention is also equally applicable to other organs besides the lung, including the breast, brain, liver, pancreas, polyps of the colon and enlargement of lymph nodes.

What is claimed is:

1. A method for detecting nodules in a tissue, comprising the steps of:
(a) providing a plurality of asymmetric templates of at least one 3D appearance model of a nodule;
(b) providing a 3D imaging data set of the entire area of a tissue;
(c) matching the 3D imaging data set of the entire area of the tissue with each of the plurality of asymmetric templates to search for 3D objects in the tissue that match the at least one 3D appearance model; and
(e) providing an output representing 3D objects that match the 3D appearance model.

2. The method of claim 1, wherein the tissue is lung tissue and the nodule is a tumor.

3. The method of claim 2, wherein the at least one 3D appearance model has a spherical shape and uniform density.

4. The method of claim 3, wherein the asymmetric templates include at least three computed tomography image scans of the model.

5. The method of claim 4, wherein the at least three computed tomography image scans are images of parallel planes across the model, one of the three scans being an image of the center of the model.

6. The method of claim 2, wherein the asymmetric templates are of a plurality of 3D appearance models having various sizes.

7. The method of claim 6, wherein prior to step (d), the method further comprises the step of:
removing redundant information of a 3D object in the lung tissue matches more than one 3D appearance models.

8. The method of claim 2, wherein step (b) comprises:
(b-1) obtaining 3D imaging scans of a chest area;
(b-2) isolating data representing the lung tissue from the scans of the chest area;
(b3) removing data of areas surrounding the lung tissue; and
(b-4) removing data representing vessels or lesions from the data of the lung tissue.

9. The method of claim 8, wherein step (c) comprises:
calculating 3D normalized cross-correlation coefficients between regions around each voxel in the entire area of the lung tissue and the templates.

10. The method of claim 1, prior to step (d), the method further comprises the step of:
determining the volume of the 3D objects found in the tissue.

11. The method of claim 10, wherein the step of determining the volume of the 3D objects is used to determine the growth rate of the 3D objects found in the tissue.

12. A system for detecting tumors in a tissue, comprising of:
a device for providing a plurality of asymmetric templates of at least one 3D appearance model of a tumor;
a device for providing a 3D imaging data set of the entire area of a lung tissue;
a device for matching the 3D imaging data set of the entire area of the tissue with each of the plurality of asymmetric templates to search for 3D objects in the tissue that match the at least one 3D appearance model, and determining the volume of the 3D objects found in the tissue; and
a display for providing an output representing 3D objects in the lung tissue that match the 3D appearance model.

13. The system of claim 12, wherein the at least one 3D appearance model has a spherical shape and uniform density.

14. The system of claim 13, wherein the asymmetric templates include at least three computed tomography image scans of the model, wherein the scans are images of parallel planes across the model, and one of the three scans is an image of the center of the model.

15. The system of claim 14, wherein the device for providing at least one model provides a plurality of 3D appearance models having various sizes.

16. The system of claim 15, further comprising a device for searching and removing redundant data information when a 3D object in the lung tissue matches more than one of the 3D appearance models.

17. The system of claim 16, wherein the device for providing the 3D imaging data set has the functions of:
isolating data representing the lung tissue from 3D scans of a chest area;
removing data of areas surrounding the lung tissue; and
removing data representing vessels or lesions.

18. The system of claim 17, wherein the device for matching the 3D imaging data set with the plurality of asymmetric templates calculates 3D normalized cross-correlation coefficients between regions around each voxel in the entire area of the lung tissue and the asymmetric templates.
